(19) United States
(12) Patent Application Publication
(10) Pub. No.: US 2024/0380022 A1
(43) Pub. Date: Nov. 14, 2024

(54) BATTERY PACK

(71) Applicant: SK On Co., Ltd., Seoul (KR)

(72) Inventors: Jung Hun OH, Daejeon (KR); Seok Min KIM, Daejeon (KR)

(21) Appl. No.: 18/656,596

(22) Filed: May 7, 2024

(30) Foreign Application Priority Data
May 11, 2023 (KR) 10-2023-0061200

(51) Int. Cl. H01M 10/6552; H01M 10/615; H01M 10/653; H01M 10/6554; H01M 50/249

(52) U.S. Cl. CPC H01M 10/6552; H01M 10/615; H01M 10/653; H01M 10/6554; H01M 50/249

(57) ABSTRACT

A battery cell of the present disclosure includes an electrode assembly including a cathode, an anode, and a separator; an exterior material accommodating the electrode assembly therein; a notch portion recessed from an inner surface of the exterior material toward the outside and provided in the form of a groove; and a protrusion portion corresponding to the notch portion on an outer surface of the exterior material provided in an opposite direction of the inner surface and protruding toward the outside.

### CROSS-REFERENCE TO RELATED PATENT APPLICATION

The present application claims priority under 35 U.S.C. § 119 (a) to Korean patent application number 10-2023-0061200 filed on May 11, 2023, in the Korean Intellectual Property Office, the entire disclosure of which is incorporated by reference herein.

### BACKGROUND OF THE INVENTION

### 1. Field

The present application relates to a battery pack. Specifically, the present application relates to a battery pack and applications of the battery pack.

### 2. Description of the Related Art

Recently, demand for mobile devices such as smartphones, tablet PCs, and wireless earphones is increasing. In addition, as the development of electric vehicles, energy storage batteries, robots, and satellites is in full swing, research is being actively conducted on high-performance secondary batteries allowing for repeated charging and discharging as an energy source.

Currently commercialized secondary batteries include nickel cadmium batteries, nickel hydrogen batteries, nickel zinc batteries, and lithium secondary batteries. Among these, lithium secondary batteries have almost no memory effect compared to nickel-based secondary batteries, allowing free charging and discharging and exhibiting very low self-discharge rates and high energy density.

### SUMMARY OF THE INVENTION

An object of the present application is to provide a battery pack that effectively prevents thermal runaway propagation and has excellent heat dissipation properties.

In addition, another object of the present application is to provide an electric device including one or more battery packs.

The battery pack of the present application can be widely applied in the field of green technology using batteries, such as electric vehicles. In addition, the battery cell of the present application can be used in eco-friendly electric vehicles, hybrid vehicles, etc. to prevent climate change by suppressing air pollution and greenhouse gas emissions.

A battery pack according to one example of the present application may include: a first pack unit; and a second pack unit spaced apart from and positioned adjacently to the first pack unit, wherein the first pack unit and the second pack unit each include a heating element and a plate thermally contacting with the heating element, the first pack unit and the second pack unit are connected through a frame, and the frame provides a thermal transfer pathway through which heat generated from a heating element of the first pack unit is transferred to the second pack unit.

In a battery pack according to one example of the present application, the heating element may be a battery cell unit body including one or more battery cells.

A battery pack according to one example of the present application further may further include a fixing portion, wherein the fixing portion may couple and connect the frame to each of the first pack unit and the second pack unit.

In a battery pack according to one example of the present application, the fixing portion may couple and connect the frame to each of a plate of the first pack unit and a plate of the second pack unit.

In a battery pack according to one example of the present application, the frame may include a main body region, wherein in the main body region, the frame may include a supporting body and an internal space in which a heat transfer preventing material may be included by the supporting body.

A battery pack according to one example of the present application may satisfy Equation 1 below:

$${d}_{TW} > d \qquad [ Equation 1 ]$$

wherein in Equation 1, d_{TW} is a minimum movement distance of heat transferred through a heat transfer pathway, and d refers to a spacing distance between a first pack unit and a second pack unit.

A battery pack according to one example of the present application may satisfy Equation 2 below:

$${d}_{TW} > {d}_{M} \qquad [ Equation 2 ]$$

wherein in Equation 2, d_{TW} is a minimum movement distance of heat transferred through a heat transfer pathway, and d_{M} refers to a minimum distance between a heating element of a first pack unit and a heating element of a second pack unit.

In a battery pack according to one example of the present application, the frame may have a thermal conductivity of 300 W/m·K or less.

In a battery pack according to one example of the present application, the frame may include one or more selected from the group consisting of aluminum and stainless steel.

In a battery pack according to one example of the present application, one or more selected from the group consisting of a plate of the first pack unit and a plate of the second pack unit may include an upper plate thermally contacting with the heating element and a lower plate coupled with the upper plate and provided with a flow path.

In a battery pack according to one example of the present application, a heat transfer medium may pass through the flow path.

In a battery pack according to one example of the present application, one or more selected from the group consisting of a plate of the first pack unit and a plate of the second pack unit may include a lower plate provided with an auxiliary flow path in a region facing the frame.

In a battery pack according to one example of the present application, one or more selected from the group consisting of the first pack unit and the second pack unit may include a heat transfer material between the heating element and a plate.

In a battery pack according to one example of the present application, the heat transfer material may include an adhesive ingredient and a heat dissipating ingredient.

In a battery pack according to one example of the present application, only the frame may provide a heat transfer path.

The present application can provide a battery pack that effectively prevents thermal runaway propagation and has excellent heat dissipation properties.

The present application can provide an electric device including one or more battery packs.

### BRIEF DESCRIPTION OF THE DRAWINGS

FIG. 1 shows a diagram briefly illustrating an exemplary structure of a battery pack.

FIG. 2 shows a diagram briefly illustrating an exemplary structure of a battery pack, and shows a diagram taken along the AA′ cross-section in FIG. 1.

FIG. 3 shows a diagram briefly illustrating an exemplary structure of a battery pack according to one example of the present application.

FIG. 4 shows a diagram briefly illustrating an exemplary structure of a battery pack according to one example of the present application, and shows a diagram taken along the BB′ cross-section in FIG. 3.

FIG. 5 shows a diagram briefly illustrating an exemplary structure of a battery pack according to one example of the present application.

FIG. 6 shows a diagram briefly illustrating an exemplary structure of a battery pack according to one example of the present application, and shows a diagram taken along the BB′ cross-section in FIG. 3.

FIG. 7 shows a diagram briefly illustrating an exemplary structure of a battery pack according to one example of the present application.

FIG. 8 shows a diagram briefly illustrating an exemplary structure of a battery pack according to one example of the present application.

FIG. 9A and FIG. 9B show a diagram briefly illustrating an exemplary structure of a battery pack according to one example of the present application, and shows a diagram taken along the CC′ cross-section in FIG. 7.

FIG. 10 shows a diagram briefly illustrating an exemplary structure of a battery pack according to one example of the present application.

FIG. 11 shows a diagram briefly illustrating an exemplary structure of a battery pack according to one example of the present application.

### DETAILED DESCRIPTION

The structural or functional descriptions of embodiments disclosed in the present application are merely illustrated for the purpose of explaining embodiments according to the technical principle of the present invention. In addition, embodiments according to the technical principle of the present invention may be implemented in various forms in addition to the embodiments disclosed in the present application. In addition, the technical principle of the present invention is not construed as being limited to the embodiments described in the present application.

Among the physical properties mentioned in the present application, in cases where the measurement temperature affects the physical properties, unless otherwise specified, the physical properties are the physical properties measured at room temperature and normal pressure.

The term ‘room temperature,’ as used in the present application, is a natural temperature that is not heated or cooled, and it may refer to, for example, any temperature in the range of 10° C. to 30° C., for example, about 15° C. or higher, about 18° C. or higher, about 20° C. or higher, about 23° C. or higher, about 27° C. or lower, or 25° C. Unless otherwise specified in the application, the unit of temperature is Celsius (° C.).

Among the physical properties mentioned in the present application, in cases where the measured pressure affects the physical properties, unless otherwise specified, the physical properties are the physical properties measured at normal pressure.

The term ‘normal pressure,’ as used in the present application, is a natural pressure that is not pressurized or depressurized, and an atmospheric pressure in the range of about 700 mmHg to 800 mmHg is typically referred to as normal pressure.

The term ‘a to b,’ as used in the present application, includes within the range between a and b including a and b. For example, including a to b parts by weight has the same meaning as including within the range of a to b parts by weight.

Unless otherwise specified, the terms ‘thickness (or height),’ ‘length,’ and ‘breadth,’ as used in the present application, mean average values and are measured using a measuring device capable of measuring thickness (or height), length, and breadth, respectively, using methods known in the art.

There are cases where thermal runaway occurs in a lithium secondary battery due to mechanical abnormal conditions, electrical abnormal conditions, thermal abnormal conditions, or internal short circuits. In the lithium secondary battery, when a separator between an anode and a cathode is damaged, the stored electrochemical energy is spontaneously released along with heat generation as the anode and the cathode come into contact.

On the other hand, a battery cell unit 2 including one or more battery cells 2a, a battery management system (BMS), and various control devices (e.g., cooling devices), and a protection system are together referred to as a battery pack (1). Korea Patent Publication No. 10-2022-0142853 discloses an example of a battery pack. In addition, a battery cell unit 2 may be a collection of one or more battery cells 2a, or may be a so-called battery module in which the one or more battery cells 2a are placed in a housing. Korea Patent Publication No. 10-2022-0150693 discloses an example of a battery module.

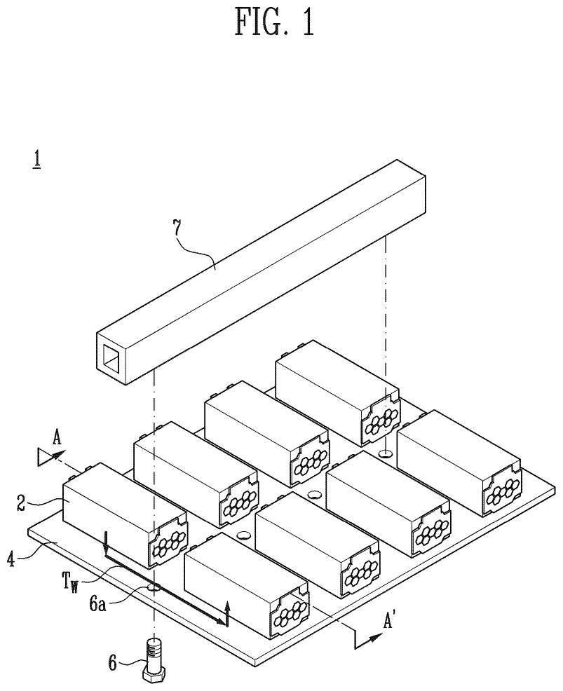

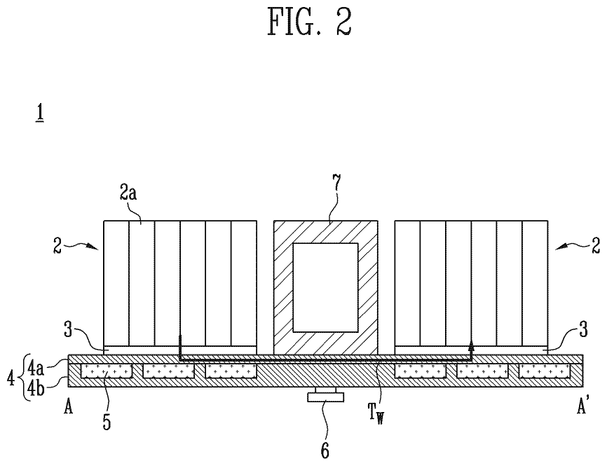

FIGS. 1 and 2 show diagrams briefly illustrating an exemplary structure of a battery pack. FIG. 2 shows a diagram taken along the AA′ cross-section in FIG. 1. Referring to FIG. 1, a battery pack 1 includes one or more battery cell units 2, and the battery cell units 2 are seated on a plate 4. The plate 4 has a flat shape made of a metal material, and the metal material may include aluminum. In addition, referring to FIG. 1, the battery pack 1 may fix a center frame 7 with a fixing portion 6 to fix and partition the battery cell units 2, and the fixing portion 6 may pass through a fixing hole 6a formed on the plate 4 and be inserted into a female screw hole formed on the center frame 7.

Referring to FIG. 2, a battery pack 1 may include a thermal interface material 3 that transfers heat generated from a battery cell unit 2 to a plate 4, and the thermal interface material 3 may be positioned between a battery cell unit 2 and a plate 4. In addition, a plate 4 may include an upper plate 4a contacting with the battery cell unit 2 through a thermal interface material 3 and a lower plate 4b forming a flow path through which a refrigerant 5 (e.g., water) passes.

In a battery pack 1 according to FIGS. 1 and 2, a battery cell unit 2 is seated on an integrated plate 4. In this case, when thermal runaway occurs in the battery cell unit 2, a large amount of heat may easily be transferred to another battery cell unit 2 through the plate 4 (thermal runaway propagation). For example, the heat may be transferred along the heat transfer pathway T_{W} shown in FIGS. 1 and 2. This transition may cause an uncontrollable fire and an explosion phenomenon.

The present application can provide a battery pack 10 that effectively prevents a thermal runaway propagation phenomenon and has excellent heat dissipation properties. In addition, the present application may provide an electric device including one or more battery packs 10.

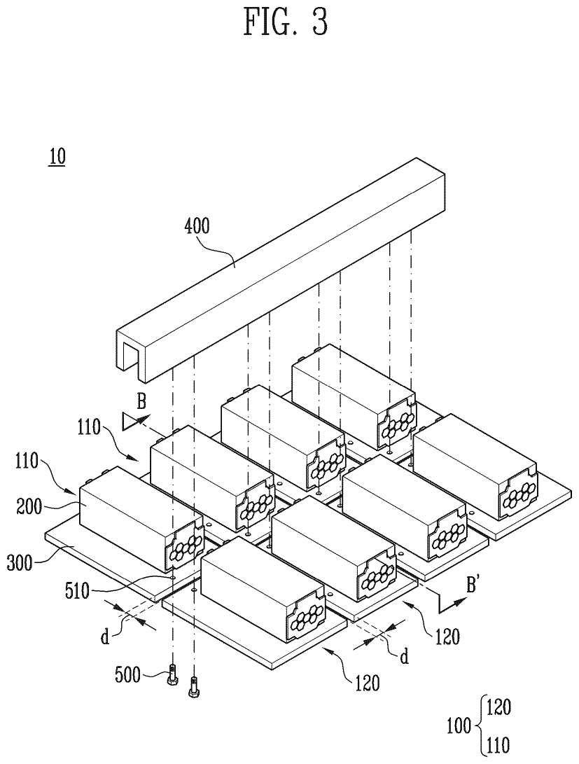

The battery pack 10 according to an example of the present application may include a pack unit 100. The battery pack 10 may include one or more pack units 100, and in another example, the battery pack 10 may include a plurality of pack units 100 (see FIG. 3).

The term ‘pack unit 100,’ as used in the present application, may refer to a unit that enables a battery pack 10 according to an example of the present application to generate electrical energy so that an electric device may operate and to dissipate at least a part of the heat formed by the generation of electrical energy.

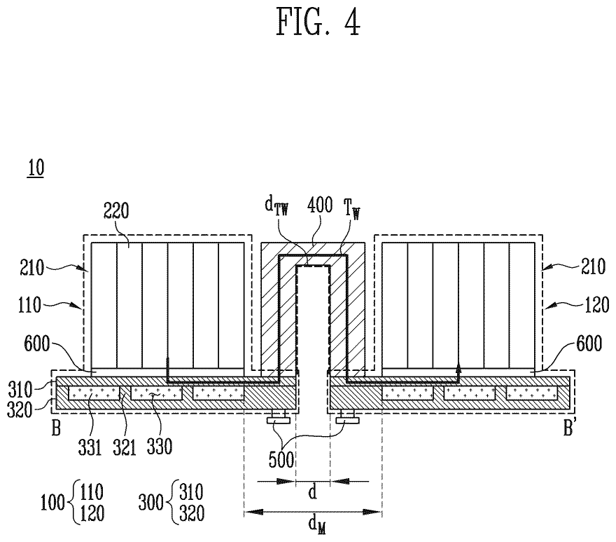

In a battery pack 10 according to an example of the present application, a pack unit 100 may include a heating element 200 (see FIG. 3). A heating element 200 may generate electrical energy and may dissipate heat due to the generation of electrical energy. For example, the heating element 200 may be a battery cell unit 210 including one or more battery cells 220 (see FIG. 4). The term ‘battery cell unit 210,’ as used in the present application, may refer to a single battery cell 220, may refer to a plurality of battery cells 220 gathered together and electrically connected to each other, and may refer to a battery module in which one or more battery cells 220 are placed in a housing. In the battery pack 10, when a heating element 200 is made of a battery cell 220 without a housing, the battery pack 10 may be referred to as a so-called cell-to-pack.

The term ‘electrically connected,’ as used in the present application, may refer to a state in which an electric circuit is configured when connected objects are connected by a connecting means, and an electric current may flow to each connected object. The connecting means is not particularly limited as long as electrical connection is possible, but may be direct contact between connected objects or a wire through which a current may flow. The plurality of battery cells 220 may be electrically connected to each other through serial connection, parallel connection, or a combination thereof.

The term ‘battery module,’ as used in the present application, may refer to a structure in which one or more battery cells 220 are placed in a housing to protect them from external shock, heat, vibration or the like. The battery module can be distinguished from an assembly of battery cells 220 in the sense that the battery module has a structure in which one or more battery cells 220 are placed in a housing.

In a battery pack 10 according to an example of the present application, the structure of a battery cell 220 may be one that is known. The battery cell 220 may include an electrode assembly and an electrolyte solution. In another example, the battery cell 220 may include an electrode and a solid electrolyte layer, and the solid electrolyte layer may have a separator function. A battery cell 220 including the solid electrolyte layer may be referred to as an all-solid-state battery.

In a battery pack 10 according to an example of the present application, the electrode assembly may include an electrode. The electrode may be a cathode or an anode. In addition, the electrode may be a term encompassing a cathode and an anode. The electrode assembly may include a separator. The separator may be interposed between a cathode and an anode.

In addition, the battery cell 220 may have a structure in which the electrode assembly is embedded into a space sealed with an exterior material and filled with an electrolyte solution. The term ‘sealed space,’ as used in the present application, may refer to a space that is closed to such an extent that when there is a liquid material in the space, the liquid material does not leak to the outside.

The cathode may refer to a reduction electrode through which an electron transfer material receives transferred electrons when a battery cell 220 is discharged. The anode refers to an oxidation electrode through which an electron transfer material transfers electrons when a battery cell 220 is discharged.

In addition, the separator refers to a membrane through which an electron transfer material passes while preventing an electrical short circuit between a cathode and an anode. The separator may be used without particular limitations as long as it is commonly used in the art. In particular, it is preferable that the separator has low resistance to ion migration of an electrolyte solution and has excellent wettability of the electrolyte solution. In addition, the electrolyte solution refers to a medium that causes movement of an electron transfer material to allow for a smooth electrochemical reaction between a cathode and an anode.

In the above, batteries are classified into various types depending on the type of the electron transfer material. For example, when the electron transfer material is lithium (Li, including ions), the battery is referred to as a lithium ion battery.

In addition, the exterior material may protect the electrode assembly from external shock and prevent (i.e., seal) an electrolyte solution from leaking to the outside. Depending on the shape of the exterior material, battery cells 220 may be classified into a prismatic shape, a cylindrical shape, or a pouch shape.

In the battery pack 10 according to an example of the present application, a pack unit 100 may include a plate 300 thermally contacting with a heating element 200 (see FIG. 3). The term, ‘thermal contact,’ as used in the present application, may refer to a state in which two objects are in direct or indirect contact so that heat may be transferred to each other. Here, the transfer of heat may refer to conduction. In addition, a state of direct contact may refer to a state in which two objects are physically in direct contact with each other in at least some regions. In addition, an indirect contact state may refer to a state in which another material is positioned between two objects and heat is transferred through the material.

A battery pack 10 according to an example of the present application may include a plurality of pack units 100. The battery pack 10 may include a first pack unit 110 and a second pack unit 120. The second pack unit 120 may be positioned adjacently to and spaced apart from the first pack unit 110.

The term ‘first pack unit 110,’ as used in the present application, may refer to one specified pack unit 100 among a plurality of pack units 100. In addition, the term ‘second pack unit 120,’ as used in the present application, may refer to a different pack unit that is not the first pack unit 110 among the plurality of pack units 100 and is positioned adjacently to and spaced apart from the first pack unit 110.

The term ‘positioned adjacently and spaced apart,’ as used in the present application may mean being positioned in the vicinity while being spaced apart without physical contact. Referring to FIG. 3, the battery pack 10 includes a plurality of pack units 100, one of which may be referred to as a first pack unit 110. In addition, referring to FIG. 3, the battery pack 10 includes a second pack unit 120 that is positioned adjacently to and spaced apart from the first pack unit 110.

In the battery pack 10 according to an example of the present application, as described above, a first pack unit 110 and a second pack unit 120 may each include a heating element 200 and a plate 330 thermally contacting with the heating element 220. Referring to FIG. 3, a first pack unit 110 and a second pack unit 120 each independently include a heating element 200 and a plate 300.

In the battery pack 10 according to an example of the present application, the first pack unit 110 and the second pack unit 120 may be positioned spaced apart from each other. That is, a first pack unit 110 and a second pack unit 120 may not be in contact with each other based only on their own components. Referring to FIGS. 3 and 4, a first pack unit 110 and a second pack unit 120 are spaced apart with an appropriate spacing distance d. In addition, referring to FIGS. 3 and 4, the spacing distance d is not particularly limited and may be determined according to the design of a battery pack 10.

A battery pack 10 according to an example of the present application may further include a frame 400 (see FIG. 3). In the battery pack 10, a first pack unit 110 and a second pack unit 120 may be connected through the frame 400. Referring to FIG. 3, the battery pack 10 includes a frame 400 connecting the first pack unit 110 and the second pack unit 120.

In a battery pack 10 according to an example of the present application, a frame 400 may provide a thermal transfer pathway T_{W} through which heat generated from a heating element 200 of the first pack unit 110 is transferred to the second pack unit 120. In addition, in the battery pack 10, the frame 400 may at the same time provide a heat transfer path T_{W} through which heat generated from the heating element 200 of the second pack unit 120 is transferred to the first pack unit 110.

In the present application, a heat transfer path T_{W} may refer to a pathway through which the heat is transferred through a component having a thermal conductivity of 1 W/m·K or more. The frame 400 may have a thermal conductivity of 1 W/m·K or more. With respect to the term ‘thermal conductivity,’ as used in the present application, when the thermal conductivity value of a specific object is widely known (e.g., thermal conductivity disclosed in United States: N.p., 1984. Web (“Thermal conductivity of aluminum, copper, iron, and tungsten for temperatures from 1 K to the melting point,” Hust, J G, and Lankford, A B., Jun. 1, 1984), the value may be referred to as the thermal conductivity used in the present application, and when the thermal conductivity value of the specific object is not widely known, the thermal conductivity measured according to ASTM E1461 may be referred to as the thermal conductivity used in the present application.

In the battery pack 10 according to an example of the present application, a frame 400 may include one or more selected from the group consisting of aluminum and stainless steel. When the frame 400 includes the above-described material, an appropriate strength of the battery pack 10 can be achieved.

In addition, in a battery pack 10 according to an example of the present application, a frame 400 is not particularly limited as long as it may form a heat transfer path T_{W}, but it may have a thermal conductivity of 300 W/m·K or less, 280 W/m·K or less, 260 W/m·K or less or 240 W/m·K or less. In another example, the frame may have a thermal conductivity of 100 W/m·K or less, 90 W/m·K or less, 80 W/m·K or less, 70 W/m·K or less, 60 W/m·K or less or 50 W/m·K or less.

In a battery pack 10 according to an example of the present application, a heating element 200 of each pack unit 110, 120 may generate heat by driving of the heating element 200 or a phenomenon such as thermal runaway. In addition, the heat transfer pathway T_{W} may refer to a pathway of heat transferred through conduction.

Referring to FIG. 4, heat generated in a battery cell unit 210 of a first pack unit 110 may be conducted to a second pack unit 120 through a frame 400. That is, referring to FIG. 4, the frame 400 provides a thermal transfer pathway.

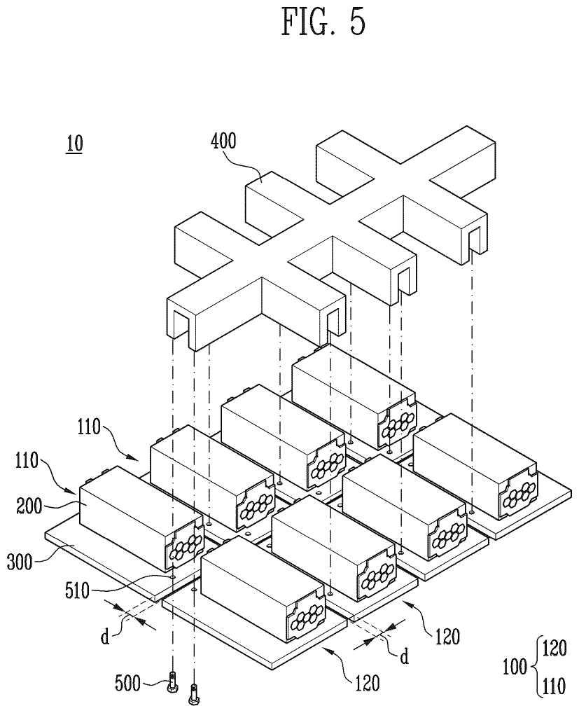

The shape of the frame 400 is not particularly limited, and the shape of the frame 400 shown in FIGS. 3 and 4 is only an example. FIG. 5 shows a diagram briefly illustrating an exemplary structure of a battery pack 10 according to one example of the present application. Referring to FIG. 5, a frame 400 may have a different appearance from the frame 400 in FIG. 3. That is, the shape of the frame 400 is not particularly limited as long as it may connect each of pack units 100 while having the structural stiffness of a battery pack 10 according to an example of the present application.

A battery pack 10 according to an example of the present application may satisfy Equation 1 below. The shape of the frame 400 may not be particularly limited as long as it satisfies Equation 1 below.

$${d}_{TW} > d \qquad [ Equation 1 ]$$

In Equation 1, d_{TW} is a minimum movement distance of heat transferred through a heat transfer pathway T_{W}, and d refers to a spacing distance between a first pack unit 110 and a second pack unit 120.

The heat transfer pathway T_{W} may be a pathway through which heat moves along a direction from a position where the temperature is to position where the temperature is low in a frame 400. In addition, the minimum movement distance of heat d_{TW} may refer to a minimum movement distance of heat transferred through the heat transfer pathway T^{W}. Here, transfer of heat may mean transfer through conduction.

Referring to FIG. 4, the minimum movement distance d_{TW} of heat transferred through the heat transfer pathway T_{W} can be known. The heat transfer pathway T_{W} may be a pathway through which heat moves along a direction from a position where the temperature is to position where the temperature is low in a frame 400. Here, the minimum distance in which the heat moves is equal to d_{TW} in FIG. 4.

The spacing distance d between the first pack unit 110 and the second pack unit 120 may specifically refer to a minimum distance between the first pack unit 110 and the second pack unit 120 (see FIG. 4).

In the battery pack 10 according to an example of the present application, when a heat transfer pathway T_{W} of a frame 400 is longer than a spacing distance (d) between a first pack unit 110 and a second pack unit 120, a thermal runaway propagation phenomenon can be effectively prevented.

In other words, in a battery pack 10 according to an example of the present application, when the above-described Equation 1 is satisfied, a thermal runaway propagation phenomenon can be effectively prevented.

A battery pack 10 according to an example of the present application may satisfy Equation 2 below. The shape of the frame 400 may not be particularly limited as long as it satisfies Equation 2 below.

$${d}_{TW} > {d}_{M} \qquad [ Equation 2 ]$$

In Equation 2, d_{TW} is a minimum movement distance of heat transferred through a heat transfer pathway T_{W}, and d_{M} refers to a minimum distance between a heating element 200 of a first pack unit 110 and a heating element 200 of a second pack unit 120.

Since the minimum movement distance d_{TW} of heat is the same as described in Equation 1 above, the description thereof will be omitted. In addition, referring to FIG. 4, an example of a minimum distance d_{M} between a battery cell unit body 210, which is a heating element 200 of a first pack unit 110, and another battery cell unit body 210, which is a heating element 200 of a second pack unit 120, may be confirmed.

In a battery pack 10 according to an example of the present application, when a heat transfer pathway T_{W} of a frame 400 is longer than a minimum distance d_{M} between a heating element 200 of a first pack unit 110 and a heating element 200 of a second pack unit 120, a thermal runaway propagation phenomenon can be effectively prevented.

In other words, in a battery pack 10 according to an example of the present application, when the above-described Equation 2 is satisfied, a thermal runaway propagation phenomenon can be effectively prevented.

In a battery pack 10 according to an example of the present application, only a frame 400 may provide a heat transfer pathway T^{W}. That is, in the battery pack 10, a first pack unit 110 and a second pack unit 120 are spaced apart from each other, and heat generated may be conducted only through a frame 400. In the battery pack 10, when heat is transferred between pack units 100 only through a frame 400, a thermal runaway propagation phenomenon can be effectively prevented.

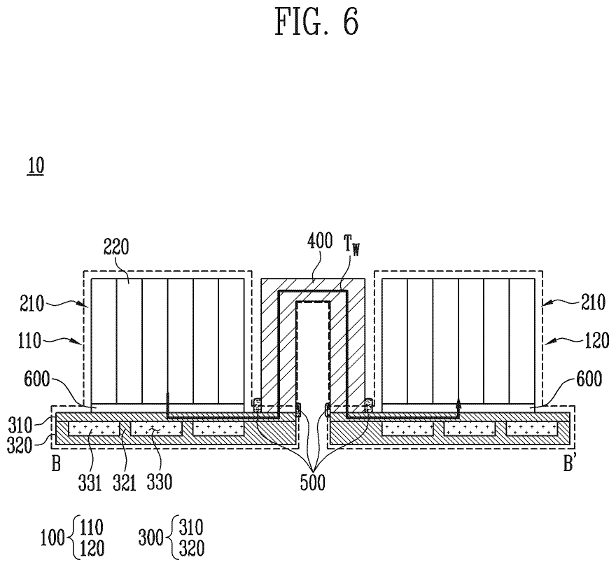

A battery pack 10 according to an example of the present application may further include a fixing portion 500. The fixing portion 500 may couple and connect a frame 400 to each of a first pack unit 110 and a second pack unit 120. Referring to FIGS. 4 and 6, a fixing portion 500 couples and connects a frame 400 to each of a first pack unit 110 and a second pack unit 120. Specifically, the fixing portion 500 may connect a frame 400 to each of a plate 300 of a first pack unit 110 and a plate 300 of a second pack unit 120.

Referring to FIGS. 3 to 5, the fixing portion 500 may be a bolt, and the fixing portion 500 may pass through a fixing hole 510 formed on each plate 300 of the pack units 110, 120 and be screwed together with a frame 400.

In a battery pack 10 according to an example of the present application, a frame 400 may include an inner groove 410, and the inner groove 410 may have a screw thread 410a. The above-described fixing portion 500 may be inserted into the inner groove 410 of the frame 400, and the inserted fixing portion 500 may couple and connect a pack unit 100 to the frame 400. In addition, the inserted fixing portion 500 may couple and connect a first pack unit 110 and a second pack unit 120 through the frame 400. In addition, the fixing portion 500 may be more strongly coupled through the screw thread 410a, thereby contributing to the durability of the battery pack 10.

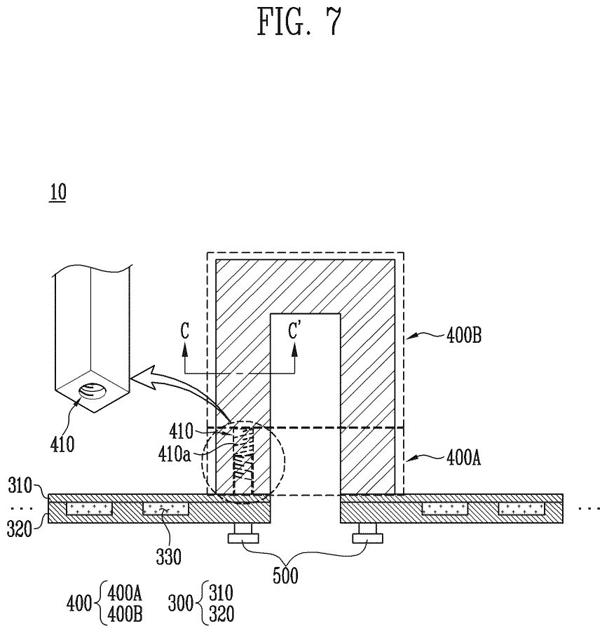

Referring to FIG. 7, a frame 400 may include an inner groove 410 formed from a part that contacts a plate 300 of each pack unit 110, 120. In addition, the bolt-shaped fixing portion 500 may be inserted into the inner groove 410, and can obtain a stronger coupling force through the screw thread 410a provided in the inner groove 410. The inner groove 410 may be a groove formed inward from a part where the frame 400 contacts the plate 300 of each pack unit 110, 120.

In FIG. 7, the part marked with a circle represents a projected inner groove 410. Referring to FIG. 7, a frame 400 may include an inner groove 410, which is a groove formed inward from a part where the frame 400 contacts the plate 300 of each pack unit 110, 120 (see the enlarged part).

In a battery pack 10 according to an example of the present application, a frame 400 may include a main body region 400B. In addition, the frame 400 may include an inner groove region 400A corresponding to the length of the inner groove 410. The main body region 400B may refer to a region other than the inner groove region 400A. Referring to FIG. 7, the inner groove region 400A and the main body region 400B of the frame 400 may be confirmed.

Referring to FIG. 6, the fixing portion 500 may be a welding material after being welded, and may weld and fix each plate 300 of the pack units 110, 120 to be connected to the frame 400.

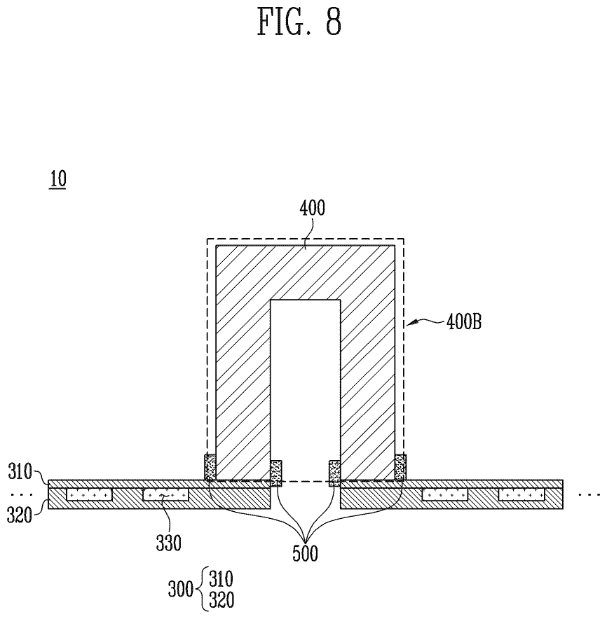

In a battery pack 10 according to an example of the present application, as described above, a frame 400 may include a main body region 400B. Referring to FIG. 8, in the battery pack 10, the frame 400 may include only a main body region 400B without an inner groove region 400A.

Referring to FIG. 8, in the battery pack 10, each plate 300 of the pack units 110, 120 and the frame 400 are connected through a fixing portion 550. In addition, the frame 400 may include a main body region 400B.

In a battery pack 10 according to an example of the present application, a frame 400 may include a main body region 400B, and in the main body region 400B, the frame 400 may include a supporting body 430 and an internal space 420 in which a heat transfer preventing material may be included by the supporting body 430.

The frame 400 may include a supporting body 430 having an appropriate thickness t. The thickness t of the supporting body 430 of the frame 400 may be designed to have an appropriate range in consideration of the stiffness of the frame 400 and the battery pack 10 and the overall weight of the battery pack 10.

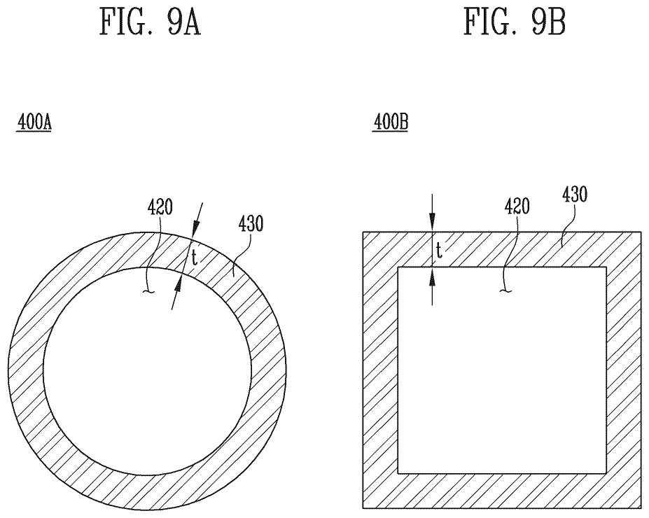

In addition, the shape of the supporting body 430 is not particularly limited and an appropriate one may be selected depending on the design, and for example, the cross-sectional shape may be circular, oval, or polygonal (rectangular, triangle, parallelogrammic, or diamond, etc.), and referring to FIG. 9A and FIG. 9B, the cross-section may be circular (see FIG. 9A) or rectangular (FIG. 9B).

In addition, referring to FIG. 9A and FIG. 9B, the supporting body 430 may form an internal space 420 by itself. In addition, an internal space 420 formed by the supporting body 430 may include a heat transfer preventing material.

The term, ‘heat transfer preventing material,’ as used in the present application, is not particularly limited as long as it is a material that interferes with the transfer of heat transferred by conduction, and may be a solid material, liquid material, or gaseous material at room temperature, and may be a mixture formed by mixing materials of various phases. The heat transfer preventing material may include, for example, air, water, or a phase change material (PCM).

When the frame 400 includes the above-described heat transfer preventing material in the internal space 420, a thermal runaway propagation phenomenon can be effectively prevented, and excellent heat dissipation properties may be achieved.

In a battery pack 10 according to an example of the present application, a plate 300 may include an upper plate 310 thermal contacting a heating element 200 and a lower plate 320 coupled with the upper plate 310 and provided with a flow path 330. Here, thermal contact is the same as the above definition.

In a battery pack 10 according to an example of the present application, at least one selected from the group consisting of a plate 300 of a first pack unit 110 and a plate 300 of a second pack unit 120 may include one an upper plate 310 thermally contacting a heating element 200 and a lower plate 320 coupled with the upper plate and provided with a flow path 330. Preferably, each plate 300 of a first pack unit 110 and a second pack unit 120 may include the upper plate 310 and the lower plate 320 (see FIGS. 4 and 6). A flow path 330 formed in a plate 300 of the first pack unit 110 and a flow path 330 formed in a plate 300 of the second pack unit 120 may be designed independently.

Referring to FIG. 4, the plate 300 includes an upper plate 310 thermally contacting the battery cell unit 210, which is a heating element 200. In addition, referring to FIG. 4, the plate 300 includes a lower plate 320 coupled with an upper plate 310. Here, the upper plate 310 and the lower plate 320 may be connected to each other by a method such as engaging, bonding, bolting, or welding, and the connection method is not particularly limited. In addition, the upper plate 310 and the lower plate 320 may be coupled to each other in contact with each other.

The lower plate 320 may include one or more bent portions 321 and may be provided with a flow path 330 through which a heat transfer medium 331 may pass when coupled with an upper plate 310 by the bent portion 321. Referring to FIG. 4, the lower plate 320 includes a bent portion 321, and the bent portion 321 creates a space between the upper plate 310 and the lower plate 320 (this space becomes a flow path 330) so that a heat transfer medium 331 passes through the space.

A heat transfer medium 331 passing through the flow path 330 may perform a heat dissipation function of absorbing heat transferred from a heating element 200. The heat transfer medium 331 is not particularly limited as long as it is a fluid that may flow in the flow path 330, but may include one or more selected from the group consisting of a gaseous medium such as air and a liquid medium such as water.

In addition, in order for a heat transfer medium 331 to pass through the flow path 330, one or more selected from the group consisting of an upper plate 310 and a lower plate 320 may include an injecting portion for injecting the heat transfer medium 331 from the outside to the flow path 330 and a discharging portion for discharging the heat transfer medium 331 to the outside.

In addition, the flow path 330 may be formed in a singular number or a plural number, and the number of bent portions 321 of a lower plate 320 may be determined depending on the number of the flow paths 330. In addition, it may be preferably that at least a part of the flow path 330 faces a bottom surface of a heating element 200. When at least a part of the flow path 330 faces a bottom surface of the heating element 200, better heat dissipation properties can be achieved. In addition, the flow path 330 may be formed through the shape and degree of bending of the bent portion 321 of the lower plate 320.

In a battery pack 10 according to an example of the present application, a lower plate 320 of a plate 300 may be provided with an auxiliary flow path 330a in a region facing a frame 400. The auxiliary flow path 330a may be provided in a singular number or a plural number. The auxiliary flow path 330a, like the above-described flow path 330, may be formed through the shape and degree of bending of the bent portion 321 of the lower plate 320.

In a battery pack 10 according to an example of the present application, one or more selected from the group consisting of a plate 300 of a first pack unit 110 and a plate 300 of a second pack unit 120 may include a lower plate provided with an auxiliary flow path 330a in a region facing a frame 400. Preferably, in the battery pack 10, the plate 300 of the first pack unit 110 and the plate 300 of the second pack unit 120 may include a lower plate 320 provided with an auxiliary flow path 330a in a region facing the frame 400.

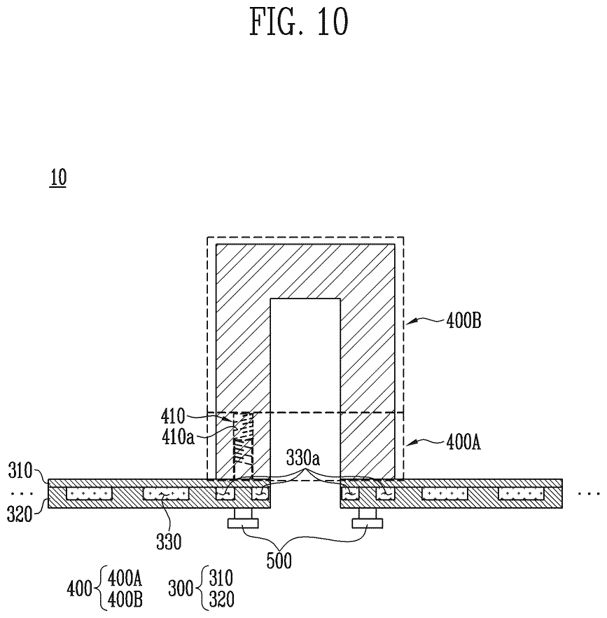

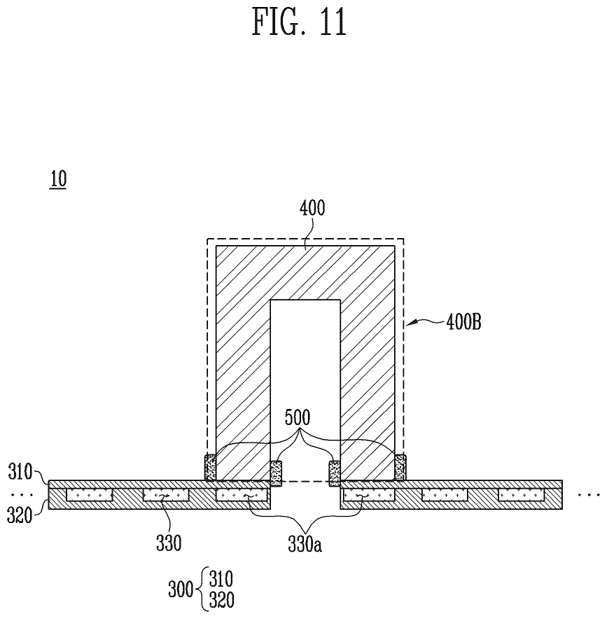

Referring to FIGS. 10 and 11, the lower plate 320 of the plate 300 includes an auxiliary flow path 330a in a region facing the frame 400.

Referring to FIG. 10, the frame 400 may include an inner groove 410, and the lower plate 320 may include an auxiliary flow path 330a in a region that faces the frame 400 but does not face the inner groove 410. When an auxiliary flow path 330a is designed as described above, the stiffness of a battery pack 10 can be achieved, a thermal runaway propagation phenomenon can be effectively prevented, and excellent heat dissipation properties can be achieved.

Referring to FIG. 11, the lower plate 320 may include an auxiliary flow path 330a in a region facing the frame 400. When an auxiliary flow path 330a is designed as described above, a thermal runaway propagation phenomenon can be effectively prevented, and excellent heat dissipation properties can be achieved.

A battery pack 10 according to an example of the present application may include a heat transfer material 600 between a heating element 200 and a plate 300 (see FIGS. 4 and 6). In addition, in the battery pack 10, one or more selected from the group consisting of a first pack unit 110 and a second pack unit 120 may include with a heat transfer material 600 between each heating element 200 and a plate 300. Preferably, in the battery pack 10, a heat transfer material 600 may be included between each heating element 200 and a plate 300 of each of a first pack unit 110 and a second pack unit 120.

In a battery pack 10 according to an example of the present application, a heat transfer material 600 may be formed in the form of a layer, and heat generated from a heating element 200 may be transferred to a plate 300 in the manner of conduction (see FIGS. 4 and 6). In addition, the heat transfer material 600 may be a heat dissipating adhesive layer, and it may be capable of adhering and fixing the heating element 200 to an upper plate 310 of a plate 300.

In addition, the heat transfer material 600 may include an adhesive ingredient. The adhesive ingredient may include one or more selected from the group consisting of a silicone resin, an acrylic resin, a urethane resin, and an epoxy resin. In addition, the adhesive ingredient may have adhesive performance by itself, or it may lack adhesive performance by itself, but may achieve adhesive performance through a curing or polymerization reaction.

In addition, the heat transfer material 600 may have a thermal conductivity of 0.1 W/m·K or more, 0.2 W/m·K or more, 0.3 W/m·K or more, 0.4 W/m·K or more, 0.5 W/m·K or more, 0.6 W/m·K or more, 0.7 W/m·K or more, 0.8 W/m·K or more, 0.9 W/m·K or more, or 1 W/m·K or more, or 10 W/m·K or less or may have a thermal conductivity of 9.5 W/m·K or less, 9 W/m·K or less, 8.5 W/m·K or less, 8 W/m·K or less, 7.5 W/m·K or less, or 7 W/m·K or less. The thermal conductivity of the heat transfer material 600 may be within a range that appears when the above-described upper limit and lower limit are appropriately selected. When the heat transfer material 600 has the above-described thermal conductivity, an excellent heat dissipation effect can be achieved. The thermal conductivity of the heat transfer material 600 refers to the value when measured in the state of being manufactured as a 20 mm sample (cured product) according to the ASTM D5470 standard or ISO 22007-2 standard along the thickness direction of the sample.

In addition, the heat transfer material 600 may include a heat dissipating ingredient. The heat dissipating material may provide heat dissipation properties to the heat transfer material 600. As the heat dissipating material, various known heat dissipating materials may be used without particular limitations. As the heat dissipating material, a ceramic filler exemplified by aluminum oxide, aluminum hydroxide, magnesium oxide, magnesium hydroxide, and boron nitride may be used.

In addition, the heat transfer material 600 may further include a flame retardant material as needed. The flame retardant material may provide flame retardancy to the heat transfer material 600. As the flame retardant material, various known flame retardants may be used without particular limitations. As the flame retardant material, a halogen flame retardant material including a halogen element (a term encompassing F, Cl, Br, and I) or a non-halogen flame retardant material that does not include a halogen element may be used or a phosphorus-based flame retardant material including phosphorus (P) or an inorganic flame retardant material exemplified by metal oxides (e.g., aluminum hydroxide) may be used.

An electric device according to an example of the present application may include one or more battery packs 10 according to an example of the present application. The above-described electric device refers to a device that operates through power generated from a battery cell 220 or the like. The electric device may be, for example, a mobile phone, home appliance, electric vehicle, hybrid vehicle, or energy storage system (ESS).

What is claimed is:

1. A battery pack comprising:
a first pack unit; and
a second pack unit spaced apart from and positioned adjacently to the first pack unit,
wherein the first pack unit and the second pack unit each include a heating element and a plate thermally contacting with the heating element,
the first pack unit and the second pack unit are connected through a frame, and
the frame provides a thermal transfer pathway through which heat generated from the heating element of the first pack unit is transferred to the second pack unit.

2. The battery pack according to claim 1, wherein the heating element is a battery cell unit body including one or more battery cells.

3. The battery pack according to claim 1, further comprising: a fixing portion, wherein the fixing portion couples and connects the frame to each of the first pack unit and the second pack unit.

4. The battery pack according to claim 3, wherein the fixing portion couples and connects the frame to each of a plate of the first pack unit and a plate of the second pack unit.

5. The battery pack according to claim 1, wherein the frame includes a main body region, wherein in the main body region, the frame includes a supporting body and an internal space in which a heat transfer preventing material may be included by the supporting body.

6. The battery pack according to claim 1, satisfying Equation 1 below:
d_{TW}>d [Equation 1]
wherein in Equation 1, d_{TW} is a minimum movement distance of heat transferred through a heat transfer pathway, and d refers to a spacing distance between the first pack unit and the second pack unit.

7. The battery pack according to claim 1, satisfying Equation 2 below:
d_{TW}>d_{M} [Equation 2]
wherein in Equation 2, d_{TW} is a minimum movement distance of heat transferred through a heat transfer pathway, and d_{M} refers to a minimum distance between a heating element of a first pack unit and a heating element of a second pack unit.

8. The battery pack according to claim 1, wherein the frame has a thermal conductivity of 300 W/m·K or less.

9. The battery pack according to claim 1, wherein the frame includes one or more selected from the group consisting of aluminum and stainless steel.

10. The battery pack according to claim 1, wherein one or more selected from the group consisting of a plate of the first pack unit and a plate of the second pack unit includes an upper plate thermally contacting with the heating element and a lower plate coupled with the upper plate and provided with a flow path.

11. The battery pack according to claim 10, wherein a heat transfer medium passes through the flow path.

12. The battery pack according to claim 10, wherein one or more selected from the group consisting of a plate of the first pack unit and a plate of the second pack unit includes a lower plate provided with an auxiliary flow path in a region facing the frame.

13. The battery pack according to claim 1, wherein one or more selected from the group consisting of the first pack unit and the second pack unit includes a heat transfer material between the heating element and a plate.

14. The battery pack according to claim 13, wherein the heat transfer material includes an adhesive ingredient and a heat dissipating ingredient.

15. The battery pack according to claim 1, wherein only the frame provides a heat transfer path.
